(19) United States
(12) Patent Application Publication
(10) Pub. No.: US 2026/0259563 A1
(43) Pub. Date: Sep. 3, 2026

(54) HYBRID AUTONOMOUS POSITIONING OF TRUSS DRIVER MACHINE

(71) Applicant: Nextpower LLC, Fremont, CA (US)

(72) Inventor: James Cheney, Novato, CA (US)

(21) Appl. No.: 19/539,667

(22) Filed: Feb. 13, 2026

Related U.S. Application Data
(60) Provisional application No. 63/764,948, filed on Feb. 28, 2025.

(51) Int. Cl. G05D 1/227; G05D 1/223; G05D 1/248; G05D 105/05; G05D 109/10

(52) U.S. Cl. CPC G05D 1/227; G05D 1/223; G05D 1/248; G05D 2105/05; G05D 2109/10

(57) ABSTRACT

Some embodiments include a user interface communicatively coupled to a foundation component driving machine, the user interface including a plurality of controls for controlling components of the foundation component driving machine, and a multi-action activation for an autonomous mode for the foundation component driving machine. Some embodiments include a machine including a base machine, an adjustable mast, a rotary driver, and a controller communicatively coupled to a user interface including multi-action activation for an autonomous mode for the machine. Some embodiments include a method for activating an autonomous mode of a foundation component driving machine, including detecting a plurality of controls triggered on a user interface, determining that the plurality of controls triggered include a first control and a second control, determining that the triggering includes a first action by the first control and a second action by the second control, and transmitting a signal to activate the autonomous mode.

### RELATED APPLICATIONS

This application claims the benefit of U.S. Provisional Patent Application No. 63/764,948, filed Feb. 28, 2025, the entire contents of which are incorporated herein by reference.

### FIELD

This disclosure generally relates to machines for driving and assembling foundations. More particularly, the present disclosure relates to hybrid autonomous positioning for use with such machines.

### BACKGROUND

Single-axis solar trackers are rapidly becoming the form factor of choice for solar power plant developers and for so-called utility-scale solar arrays. Single-axis trackers are configured as North-South oriented rows (e.g., single or double rows) of solar panels attached to a torque tube. The torque tube is attached to a motor or other drive mechanism that slowly rotates all the attached panels at once, so they move from East-facing to West-facing to follow the sun's daily movement through the sky. Keeping the panels facing the sun increases energy harvest relative to fixed-tilt arrays that do not move.

In a large-scale and/or utility-scale solar array, there may be specific locations designated for solar tracker foundation components. For instance, one of the first steps towards construction of a large-scale solar array can be performing a site survey. The site survey is usually done with a particular tracker maker's equipment in mind because the equipment will, to some extent, dictate the layout (i.e., row length, inter-row spacing, trenching, etc.). At the end of the survey, a plan is created that shows the location of the ends of each row as well as the position of each ground penetrating foundation component and any required trenches for running cables across the array. In some instances, surveyors may have to manually mark/pin where each foundation component needs to be placed in the ground. This can be inefficient and inaccurate (for example, as a top of a pile may be extrapolated to the ground during pinning, which can be a source of error).

Additionally, once a survey has been completed and pins have been placed, a user may need to manually control a machine and navigate it to the proper pin location (i.e., a user may need to manually position the machine), which again can be inefficient and can leave room for error.

### SUMMARY

In general, this disclosure is directed to machines for driving and assembling foundations and, more particularly, to hybrid autonomous positioning for use with such machines. In one example, the present disclosure includes a user interface communicatively coupled to a foundation component driving machine. The user interface can include a plurality of controls for controlling components of the foundation component driving machine. The user interface can also include a multi-action activation for an autonomous mode for the foundation component driving machine, where: the multi-action activation activates the autonomous mode, the autonomous mode is activated when all of the multi-actions are triggered, and each action of the multi-action activation is triggered by a control from the plurality of controls.

In another example, the present disclosure includes a machine for positioning and driving foundation components. The machine can include a base machine. The machine can also include an adjustable mast attached to the base machine. The machine can also include a rotary driver movably attached to the mast. The machine can also include a controller. The controller can be communicatively coupled to a user interface. The user interface can include a multi-action activation for an autonomous mode for the machine. In some embodiments, triggering the multi-action activation on the user interface causes the controller to execute autonomous control of the machine.

In another example, the present disclosure includes a method for activating an autonomous mode of a foundation component driving machine. The method can include detecting a plurality of controls triggered on a user interface, the user interface communicatively coupled to the foundation component driving machine. The method can also include determining that the plurality of controls triggered include a first control and a second control. The method can also include determining that the triggering includes a first action by the first control and a second action by the second control. The method can also include transmitting, to the foundation component driving machine, a signal to activate the autonomous mode for the foundation component driving machine.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present invention and, therefore, do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is an example foundation component driving machine, according to an embodiment.

FIG. 2 is an example screw anchor foundation component driven by the machine, according to an embodiment.

FIG. 3 is an example EARTH TRUSS foundation, according to an embodiment.

FIG. 4 is an example tracker array system at a tracker array site, according to an embodiment.

FIG. 5 is an example user interface connected to a foundation component driving machine, according to an embodiment.

FIG. 6 is an example user interface connected to a foundation component driving machine, according to an embodiment.

FIG. 7 is an example user interface with a disengaged multi-action activation, according to an embodiment.

FIG. 8 is an example user interface with an engaged multi-action activation, according to an embodiment.

FIG. 9 is a flow diagram of an exemplary embodiment of a method of activating an autonomous mode of a foundation component driving machine, according to an embodiment.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

The invention will now be described in the context of the drawing figures where like elements are referred to with like designations. This description is intended to convey a thorough understanding of the embodiments described by providing a number of specific embodiments and details involving methods, machines and systems for embedding foundation components, such as foundation components for single-axis solar trackers. It should be appreciated, however, that the present invention is not limited to these specific embodiments and details, which are only exemplary. It should be further understood that one possessing ordinary skill in the art in light of known systems and methods, would appreciate the use of the invention for its intended purposes and benefits in any number of alternative embodiments, depending upon specific design and other needs. It should also be understood that the drawings are exemplary and may not be to scale.

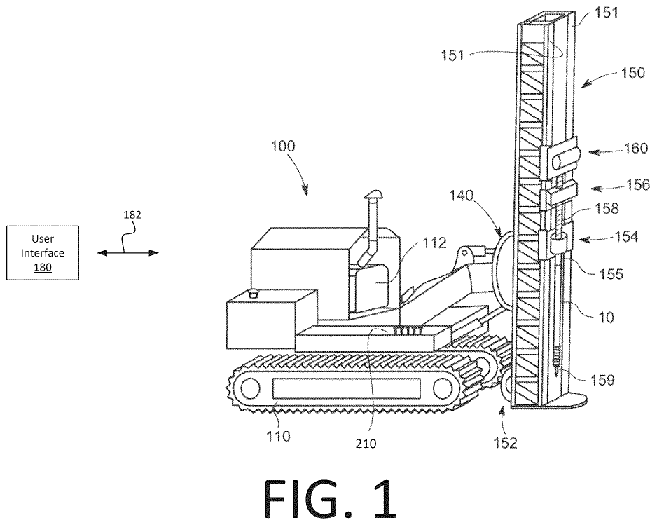

FIG. 1 illustrates a foundation component driving machine 100 in accordance with various embodiments of the invention. As one example, foundation component driving machine 100 can be a type manufactured by the applicant of this disclosure and known commercially as the TRUSS DRIVER according to various exemplary embodiments of the invention. The TRUSS DRIVER can be used to drive adjacent foundation anchor components (e.g., screw anchor pairs) into underlying ground along the tracker row according to one or more installation parameters. While FIG. 1 may depict a TRUSS DRIVER, foundation component driving machine 100 can be any type of foundation component driving machine.

In some embodiments, as shown, machine 100 is built on tracked chassis 110 with diesel motor 112 and a hydraulic drive system. It should be appreciated that other embodiments within the scope of this disclosure can include versions of the machine that are electrically powered such that an electrically driven rotary drive motor is used in place of the hydraulic drive system. Such modifications are within the spirit and scope of the invention. Also, it should be appreciated that machine 100 could instead ride on tires, on a combination of tires and tracks, on a floating barge, on rails or on another movable platform.

Machine 100 supports articulating mast 150. In the figure, mast 150 is shown as an elongated ladder-like truss structure. It can be connected to machine 100 by one or more hydraulic actuators. In various embodiments, articulating mast 150 can go from a stowed position (for example, where the mast is substantially parallel to the machine's tracks) to an in-use position (for example, where the mast is substantially perpendicular to the tracks). In various embodiments, rotator 140 is positioned in front of the one or more actuators connecting mast 150 to machine 100 so that mast 150 may rotate through a range of angles about a point of rotation (e.g., plus or minus 35-degrees from plumb) so that foundation anchor components (e.g., screw anchors) may be driven into the ground at a range of angles. This also decouples the driving angle from the left to right slope of the ground under the machine, allowing it to compensate for uneven terrain.

In various embodiments, in addition to rotating in plane, articulating mast 150 may move with respect to machine 100 so that it can self-level, adjust its pitch, and yaw and move in the X, Y and Z-directions (where X is North-South, Y is East-West, and Z is vertical) without moving the machine. This may be accomplished with additional actuators or slides that move an intermediate frame that supports rotator 140 and that is positioned between the rotator and machine 100. The components of machine 100 used to drive foundation components, such as screw anchors, as opposed to positioning the mast, are mounted on mast 150. Mast 150 includes parallel tracks 151 that define the plane that those components move in. Therefore, the mast's orientation dictates the vector or driving axis that screw anchors are driven along. Alternatively, mast components may travel on wheels retained on a track running along the mast.

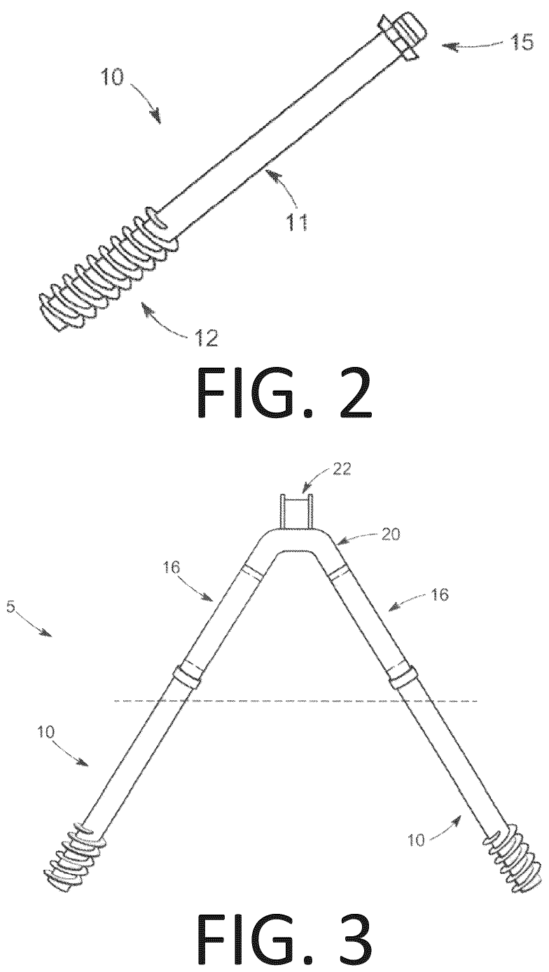

In some embodiments, as shown, the driving components can include rotary driver 154 with chuck 155 that connects to driving collar 15 (depicted in FIG. 2) of screw anchor 10. Some embodiments of the machine 100 can also include a tool driver 156, located above the rotary driver 154. In various embodiments, tool driver 156 is a hydraulic drifter that drives a tool consisting of shaft 158 and bit or tip 159 that extends along mast 150, passing through rotary driver 154, chuck 155 and the center of foundation component 10. In various embodiments, and as shown in the figures, rotary driver 154 and tool driver 156 may be oriented concentrically on mast 150 in the direction of tracks 151 so that shaft 158 can pass through rotary driver 154 while it is driving a foundation component (e.g., screw anchor). In this manner, the tool tip 159 may operate ahead of the foundation component's tip, projecting out of its open, lower end. In various embodiments, rotary driver 154 is loaded by sleeving a foundation component over tip 159 and shaft 158 until it reaches chuck 155. Alternatively, tool driver 156 may be withdrawn up mast 150 until shaft 158 and tip 159 are substantially out of the way. Then, mast 150 can be moved to the desired driving vector. In some embodiments, this may comprise aligning the mast and then rotating it in the aligned plane. In other embodiments, the entire mast may be moved so that the point of rotation is oriented somewhere along the driving axis. This will ensure that the driven foundation component 10 points at the desired work point. In various embodiments, a slide control is then adjusted for the mast to lower the mast foot to the point where at least a portion of it reaches the ground.

Machine 100 causes the foundation component to be driven to a desired embedment depth, and when the operation is complete, rotary driver 154 (and tool driver 156 if included) travels back up mast 150 so that another foundation component may be loaded before moving mast 150 in the opposing direction to drive the adjacent foundation component so that the pair straddles the intended North-South line of the tracker row and points at a common work point.

In this exemplary system, lower crowd motor 152 can be mounted near the base of mast 150 on the back side. In various embodiments, lower crowd motor 152 powers a drive train including heavy-duty single or multi-link chain that runs substantially the entire length of mast 150 between a pair of chain tensioners positioned at the top and bottom ends of mast 150. A lower carriage can be mounted on tracks 151 and can be connected to a chain so that when lower crowd motor 152 pulls down on the chain, the carriage causes rotary driver 154 to push down on the head of the attached foundation component 10 (e.g., screw anchor) with the same force. Rotary driver 154 can be attached to the lower carriage so that the two move together. Rotary driver 154 includes chuck 155 on its lower portion that receives the head of a foundation component (e.g., a head of a screw anchor) and imparts torque and downforce to the head to drive it into the underlying ground. In some embodiments, an upper carriage is also tracked on mast 150 and attached to the chain driven by lower crowd motor 152. Tool driver 156, in this example, a hydraulic drifter, can be attached to an upper carriage. Herein, the word “tip” in reference to element 159 is used generically to refer to the tool attached to the end of shaft 158 controlled by tool driver 156 and may be a drill bit (button, drag, cross, tri-cone, etc.), a pointed mandrel tip, or other suitable tool. As shown, tip 159 is controlled by tool driver 156 via a shaft 158 connected to the output of tool driver 156 and extending lengthwise down mast 150, through an opening in rotary driver 154 and out through chuck 155. With this configuration, tool driver 156 may impart torque and hammering force to tip 159 through rotary driver 154 and attached screw anchor 10 while rotary driver 154 is driving the screw anchor. Though other embodiments of the machine 100 may not include the tool driver 156. In some embodiments, machine 100 can include an upper crowd motor 160. The upper crowd motor 160 can, in some instances, move with the chain but may selectively disengage from the chain to move tool driver 156 independently.

In some embodiments, machine 100 can include a series of hydraulic controls in a control panel/controller 210. These controls may allow control of the machine tracks as well the mast, the rotary driver, tool driver, lower crowd motor, upper crowd motor, etc. Notwithstanding these controls, maximum accuracy and driving throughput may be possible by relying, in some instances, on machine automation. To that end, in various embodiments, machine 100 and mast 150 may include one or more programmable logic controllers (PLCs) executing a control program that controls the positioning and/or driving functions of machine 100, mast 150, etc.

In some embodiments, as depicted in FIG. 1, the foundation component driving machine 100 can be connected to (e.g., communicatively coupled to) a user interface 180. This is depicted by connection 182. The user interface 180 can be connected 182 to the controller 210, in some instances. In some embodiments, the user interface 180 is accessible by an operator of the machine 100 to allow the operator to manually control various functions of the machine. In some embodiments, the controller 210 can be controllable via the user interface 180 (for example, a remote control and/or another type of user interface). Controller 210 may execute program code stored in a memory (e.g., a non-volatile, non-transitory memory), in some embodiments.

FIG. 2 illustrates an exemplary screw anchor 10 usable with various embodiments of the invention. Screw anchor 10 consists of a hollow, substantially uniform diameter shaft 11 that is open at both ends with external threads 12 at one end and a driving collar 15 at the other. The length of screw anchor 10 may be variable depending on the desired depth of embedment (e.g., 1-2 meters). In the context of foundations for single-axis trackers and other axial solar arrays, embedment depth may be dictated by soil type, grade of land, torque tube height, among other factors. In an example, the inside diameter of the shaft may be between two and half and three inches and the thickness on the order of a few millimeters. It may be formed from galvanized alloy steel or other suitable material. In some cases, it may be coated with one or more additional anti-corrosion coatings such as fusion bonded epoxy, polyurethane, and acrylic, among others. Driving collar 15 may be a separate cast structure welded on to the upper end of shaft 11 or, alternatively, may be stamped or otherwise formed in the upper end. Threads 12 may be welded to the outside of shaft 11, may be attached with bent tabs or, in some cases may even be stamped into the lower end. The threads enable screw anchor 10 be driven into supporting ground with a combination of torque and downforce. The open end allows a drill or other tool to be extended through screw anchor 10 while the anchor is being driven into the ground to enable it to go through dense soil, rocks or other strata that might refuse the anchor itself.

FIG. 3 illustrates an example foundation system 5, according to an embodiment. This foundation system 5 is known commercially as EARTH TRUSS. The EARTH TRUSS system 5 shown in FIG. 3 consists of a pair of adjacent screw anchors 10 that have been driven into supporting ground at angles to one another on the East and West sides of an intended North-South line of a tracker row. Once anchors 10 have been driven to their target embedment depth, an upper leg 16 is attached to each anchor 10 via driving collar 15. In various embodiments, each upper leg 16 may be temporarily sleeved over one of the collars 15 while an adapter or truss cap 20 is fitted into the opposing ends of each upper leg 16 to complete the foundation. In various embodiments, the machine may include a jig or other device that orients the adapter or truss cap so that it is level and aligned with a laser line to be at the at the same Y (East-West) and Z (up-down) position as every other adapter in the current row. In various embodiments, once the adapter or truss cap 20 has been properly aligned, upper legs 16 may be crimped at each end, that is, at the areas of overlap with screw anchors 10 and with truss cap or adapter 20, thereby forming a rigid A-frame structure. In various embodiments, assembling the EARTH TRUSS at the time the screw anchors are driven will obviate the need for later alignment steps, such as when the tracker components are installed.

Exemplary adapter 20 shown in FIG. 3 consists of a pair of open connecting portions that, in this example, are received within respective upper legs 16, and a H-pile like mounting portion 22 that extends upward and approximates the web and flange geometry of a standard W6x9 or W6x12 H-pile. With this geometry, adapter 20 may support any tracker system that is designed to attach to an H-pile. It should be appreciated, however, that in other embodiments adapter 20 may take on a different geometry that includes an integrated bearing portion and/or that is optimized to integrate with one or more specific tracker systems. The various systems, methods and machines according to the various embodiments of the invention are agnostic as to which particular adapter is used. Regardless of which is used, in various embodiments the machine may provide a jig, bracket or other guide to hold the adapter at the desired orientation so that the EARTH TRUSS can be constructed in a fast, precise and repeatable manner.

In some embodiments, in order to form/install a solar tracker array system on a solar tracker array site, a foundation component driving machine (e.g., machine 100) can position and drive. Positioning, as referred to herein, refers to the positioning of the machine 100 at an installation point/location. In some embodiments, the installation point can include a location for each screw anchor 10 of the foundation system 5. Driving, as referred to herein, refers to the screw driving (i.e., embedding) of the screw anchors 10.

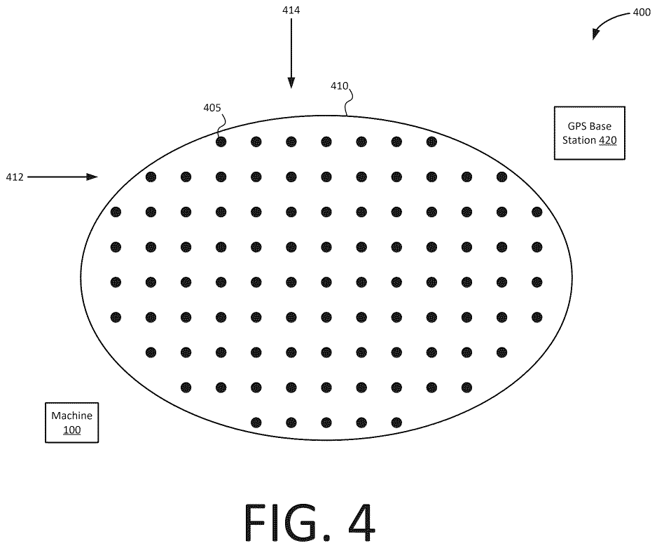

FIG. 4 illustrates an example tracker array site 400 for a tracker array system, according to an embodiment. In some instances, tracker array site 400 can be depicted prior to the installation of the screw anchors 10 and the foundation system 5 (for example, in a pre-tracker construction state). In some embodiments, tracker array site 400 can be a single-axis tracker array site. Tracker array site 400 can include a plurality of tracker installation points 405 within a tracker array 410 portion of the tracker array site 400. Tracker array 410 and installation points 405 are meant to be an exemplary layout and any other installation point 405 and tracker array 410 layout can be used. Further, tracker array site 400 can include any number of installation points 405. For example, tracker array site 400 may not be to scale and may actually include a larger number of installation points 405 (such as 250,000 installation points 405, for example). During the installation of the screw anchors 10 and the foundation system 5, machine 100 can be positioned at each installation point 405 and can then drive each screw anchor 10 into the ground at each installation point 405.

In some embodiments, during the positioning process, a user may need to manually control the machine 100 and navigate it to the proper installation point 405, which can be inefficient and can leave room for error (due to the manual process). The machine 100 can be controlled through a user interface 180, in some instances. In some embodiments, the user interface 180 can include various positioning and/or driving (i.e., embedding) controls for the machine 100.

In some embodiments, as discussed herein, a manual site survey can be performed to lay out the rows 412 and columns 414 of the tracker array site 400 and to determine the tracker installation points 405. The survey could be based on (and corresponding to) a particular tracker maker's requirements for row length, foundation spacing, motor locations and inter-row spacing, among other constraints, and could include a marker placed at each required foundation location. Typically, one or more flags, pins, or other markers can be placed in the ground at each survey point to indicate to the foundation installation crew exactly where to drive foundation components. However, as discussed herein, the manual survey process can be inefficient and time consuming (for example, due to at least the manual marking of each installation point).

Therefore, in some embodiments, to help improve the functioning of the machine 100 and the positioning process, the installation points 405 can be determined using a global positioning system (GPS). While the term GPS may be used herein, GPS (as referred to herein) is intended to include any Global Navigation Satellite System (GNSS). In some instances, the tracker array site 400 can include a GPS/GNSS base station 420. In some embodiments, the GPS/GNSS base station 405 can be a base station for real-time kinematics (RTK) corrections. For instance, the GPS/GNSS base station 420 can receive signals from GPS/GNSS satellites and can correct the satellite information based on the on-site information known by the GPS/GNSS base station 420. Because the GPS/GNSS base station 420 is on the tracker array site 400, the GPS/GNSS base station 420 can be very precise and can have accurate information specific to the actual tracker array site 400 and the specific location of the base station 420, thus allowing the GPS/GNSS base station 420 to correct various satellite information (for example, the base station 420 can correct for atmospheric conditions). This can enable centimeter (cm) precision, in some instances.

In some embodiments, the machine 100 can include a GNSS antenna (for example residing on the machine). The base station 420 can identify a specific location of the GNSS antenna, and this information can be processed (for example, by a GNSS receiver) to determine how far the machine 100 is from a desired location (for example, determine the offsets). In some embodiments, the machine 100 and/or the base station 420 are connected to a GNSS receiver and/or a GNSS positioning system, and the GNSS receiver and/or positioning system may do various calculations/determinations (for example, including calculating/determining the installation points 405). In some embodiments, the GNSS receiver may be a part of the GNSS positioning system. As an example, the installation points 405 can be determined (for example, by a GNSS receiver and/or positioning system) using a particular tracker maker's requirements for row length, foundation spacing, motor locations, inter-row spacing, etc. In some embodiments, once the installation points 405 are determined, they can be kept locally on the machine 100 (for example, in a GNSS tablet). In some embodiments, a GNSS receiver may be on the machine 100 (i.e., may be an onboard GNSS receiver).

In some instances, the GPS/GNSS base station 420 can be connected to the controller 210 and/or the user interface 180 (depicted in FIG. 1) of the machine 100. For example, the GPS/GNSS base station 420 can transmit corrections for atmospheric conditions to the controller 210 and/or the user interface 180. The machine 100 (for example, onboard GNSS positioning system equipment on the machine 100) can apply these corrections to the onboard calculations used to determine position. This can help correct any offsets to the locally stored target location (e.g., the installation point 405).

Utilizing a GPS/GNSS receiver and/or positioning system to determine the installation points 405 can increase the efficiency of determining the installation points 405 (as a manual survey may not need to be performed and markers may not need to be manually placed at each installation point 405 at the tracker array site 400) and can increase the accuracy of the installation points 405 due to the GPS/GNSS base station 420, as the base station 420 can correct for atmospheric conditions.

In instances where the machine 100 can be manually controlled by an operator, the installation points 405 can be displayed to an operator through the user interface 180 or through a separate screen and/or interface (not depicted). When the machine 100 is fully manually operated, an operator may be executing a plurality of controls to move and control the machine 100, while also watching a screen, for example, in order to see the installation point 405 where the operator may be trying to navigate the machine 100 to. This can lead to various errors and/or safety issues during the positioning process, as an operator is having to monitor both a screen/user interface (in order to see the installation points 405) and the surroundings of the machine 100, as well as control the machine 100 (for example, through a user interface 180) and drive/navigate it to the installation point 405.

Therefore, in instances where a machine 100 has autonomous capabilities, the user interface 180 may include an autonomous activation/deactivation control to allow an operator to switch back and forth between manual control and autonomous control of the machine 100. For instance, the machine 100 may have the ability to automatically position the machine at each installation point 405 and then to orient itself once at the installation point 405. This can help prevent an operator from having to monitor and control too many things at once and can, in some instances, more accurately position the machine 100 due to the autonomous capabilities. In some embodiments, when the machine 100 has autonomous positioning capabilities (i.e., can automatically position itself at the various installation points 405), the machine may continuously calculate (for example, for each of the positioning actuators of the machine 100) whether each actuator is positioned correctly and will end up on target for the positioning and the installation point 405, and can adjust, start, stop, etc. the machine 100 accordingly.

However, there are instances where the tracker array site 400 can be unlevel, include various obstacles, etc. While the machine 100 in an autonomous mode may have the capability to navigate some ground/surface challenges, there may be instances where manual navigation is helpful/preferred. For example, the machine 100 may not be able to navigate higher (for example, extreme) ground slopes (or may navigate them very slowly) and/or other extreme terrains, the machine 100 may not be able to navigate around various obstacles (e.g., rocks, boulders, or other obstacles), etc. In these instances, a manual navigation can help protect the machine 100 as an operator can view the surroundings and navigate accordingly. For example, an operator could navigate the machine 100 around an obstacle; slow down and/or speed up the machine 100 when navigating different terrains, slopes, obstacles, etc.; stop/slow down the machine 100 to let a moving obstacle pass; etc. As another example, in instances where there could be an obstacle (such as a person or animal) near the machine, an operator could release paddles and/or joysticks on a remote to stop the machine 100 and autonomous navigation. When the machine is in an autonomous mode, an operator could better watch for safety concerns as they do not need to be staring at a screen or engaged in positioning.

Having the ability to switch between autonomous and manual operation (referred to herein as hybrid autonomous) can increase the accuracy of the positioning due to the autonomous capabilities and can help prevent safety issues (due to an operator having to monitor too many things at once), while also maintaining and/or increasing the navigation through various terrains, obstacles, etc. due to the manual capabilities.

In some embodiments, the autonomous activation/deactivation control on the user interface 180 may be a multi-action control/activation (for example, a two trigger/action control). The multi-action activation can be a safety feature to help engage the operator while the machine is in autonomous mode. For example, if autonomous mode of the machine 100 could be activated by a single action (such as a press of a button), an operator may become distracted as they do not need to stay engaged with the user interface 180, which can cause possible positioning issues and/or issues with the machine 100 (for example, if the machine 100 was navigating certain terrains, slopes, obstacles, etc.). A multi-action activation can require multiple actions/triggers to occur in order for the machine 100 to switch to autonomous mode. If all of the multiple actions have not been engaged/triggered, the machine 100 may stay in manual mode, in some instances. In some instances, the machine 100 may switch from autonomous mode to manual mode as soon as any of the multiple actions have been disengaged/released (i.e., as soon as any of the actions are no longer occurring). This way, if the operator is not fully activating autonomous mode, the machine 100 can switch to manual mode where, if the operator does not operate the machine 100, the machine 100 may stop. This can help maintain safety of the machine 100, its surroundings, and any other objects/actors in the vicinity.

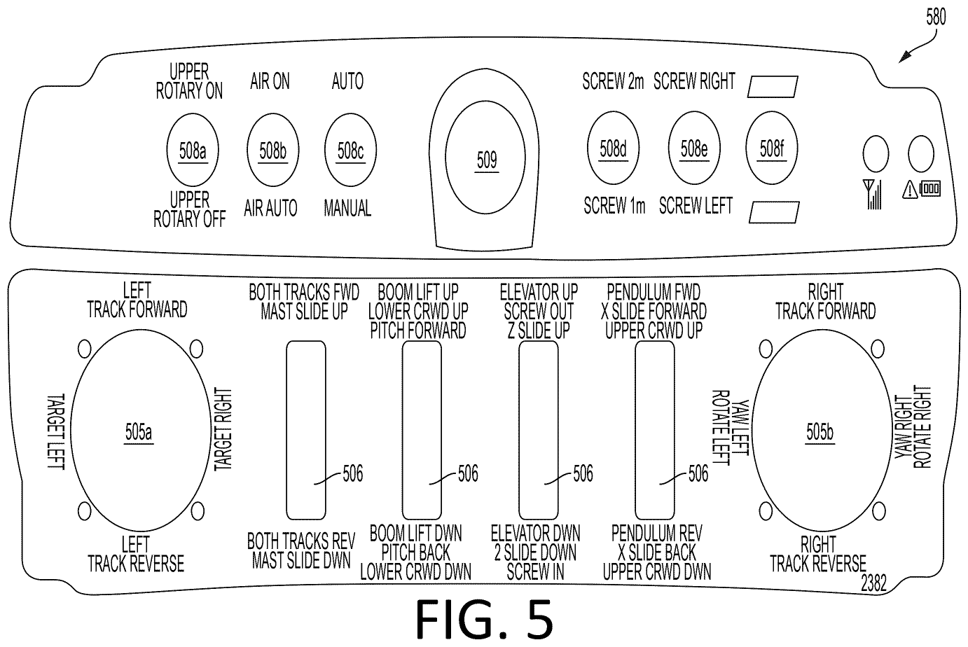

FIG. 5 illustrates an example user interface 580 with multi-action control/activation for an autonomous mode. In some embodiments, user interface 580 can be the same/similar as user interface 180 and can be connected to a foundation component driving machine such as machine 100. The user interface 580 depicted in FIG. 5 can be a remote control (referred to herein as a remote), however this is an exemplary type of user interface, and user interface 580 can include other types of user interface.

In some embodiments, as depicted in FIG. 5, user interface 580 can include a variety of controls (505, 506, 508, 509) to help control machine 100. These controls can include slides 506; switches 508a, 508b, 508c, 508d, 508e, 508f (referred to collectively as 508); button(s) 509; etc. In some embodiments, the user interface 580 is connected to a controller (such as controller 210 (FIG. 1)) so that when a control (505, 506, 508, 509) is triggered/activated on the user interface 580, the controller 210 can execute the control(s). The controller 210 can, in some instances, allow control (for example, through the controls 505, 506, 508, 509 of the user interface 580) of the machine tracks (e.g., tracks 151), mast (e.g., mast 150), rotary driver (e.g., rotary driver 154), tool driver (e.g., tool driver 156), lower crowd motor (e.g., lower crowd motor 152), upper crowd motor (e.g., upper crowd motor 160), and more.

In some embodiments, user interface 580 includes joysticks 505a, 505b (referred to collectively as joysticks 505). These joysticks 505 can, for example, control a left track (for joystick 505a) and a right track (for joystick 505b) of the machine 100. In some embodiments, the joysticks 505 can also serve as the multi-action activation of an autonomous mode of the machine 100. For example, an autonomous mode of the machine 100 may be activated through a two-action process, and the two actions (in this example) may be pushing each joystick 505 outward (i.e., to an outside of the remote/user interface 580). In some instances, the joysticks 505 may need to be pushed fully outward in order for the autonomous mode to be activated. In some instances, the joysticks 505 may need to be pushed outward simultaneously (or at least at a substantially similar time) in order for autonomous mode to be activated. As soon as one of the joysticks 505 is not pushed fully outward, the autonomous mode may stop and machine 100 may return to manual mode.

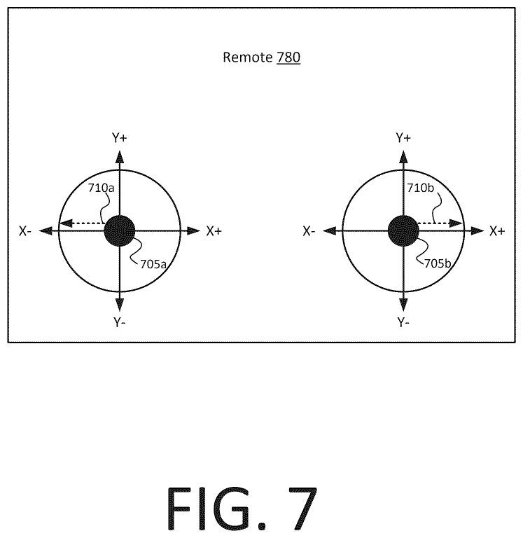

In some embodiments, the autonomous mode may be activated when the joysticks are at least 70% outward (i.e., are positioned greater than or equal to 70% towards the outward direction (e.g., towards direction 710 (depicted in FIG. 7))). In these embodiments, once either of the joysticks 505 are less than 70% outward the autonomous mode may stop. In some instances, the speed of the tracks of the machine 100 is scaled 0-100% speed correlating to 70-100% joystick 505 actuation of both joysticks. In these instances, even if the machine is in autonomous mode (as the joysticks 505 may be greater than or equal to 70% outward), the speed of the machine 100 while in autonomous mode can still be controlled by the operator (based on how far outward (e.g., how much more than 70% outward) the joysticks 505 are positioned). This can help enable an operator to slow autonomous mode instead of fully stopping autonomous mode (for example, to slow to handle an obstacle such as going through a small ditch or over a rock).

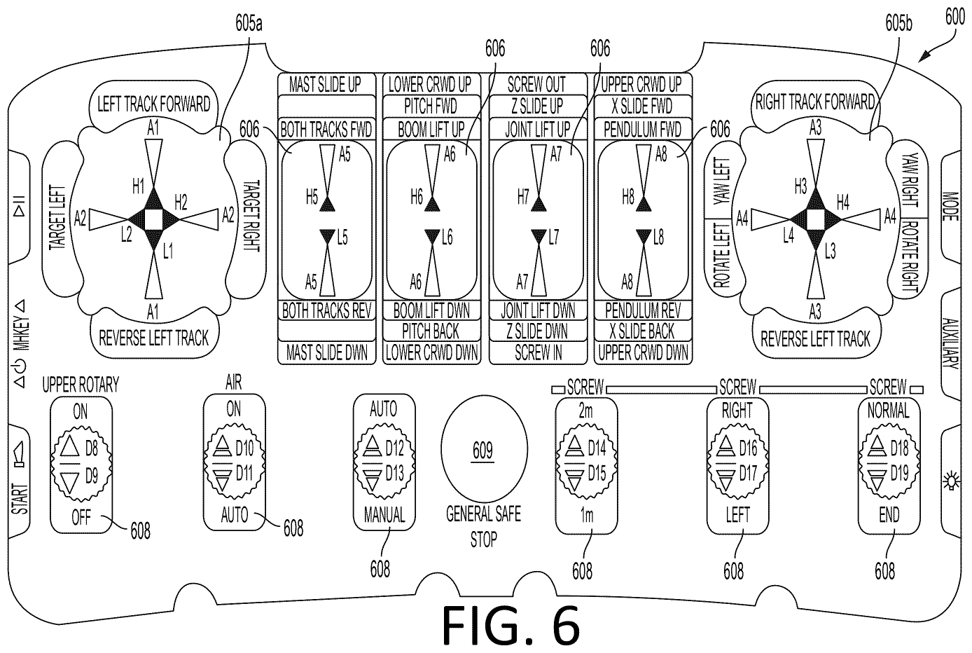

FIG. 6 illustrates an example user interface 680 with multi-action activation for an autonomous mode. In some embodiments, user interface 680 can be the same/similar as user interface 180 and can be connected to a foundation component driving machine such as machine 100. The user interface 680 depicted in FIG. 6 can be a remote control (referred to herein as a remote), however this is an exemplary type of user interface and user interface 680 can include other types of user interface.

In some embodiments, user interface 680 can include a variety of controls (605, 606, 608, 609) to help control machine 100. These controls can include slides 606, switches 608, button(s) 609; etc. In some embodiments, the user interface 680 is connected to a controller (such as controller 210 (FIG. 1)) so that when a control (605, 606, 608, 609) is triggered/activated on the user interface 680, the controller 210 can execute the control(s). The controller 210 can, in some instances, allow control (for example, through the controls 605, 606, 608, 609 of the user interface 680) of the machine tracks (e.g., tracks 151), mast (e.g., mast 150), rotary driver (e.g., rotary driver 154), tool driver (e.g., tool driver 156), lower crowd motor (e.g., lower crowd motor 152), upper crowd motor (e.g., upper crowd motor 160), and more.

In some embodiments, user interface 680 includes joysticks 605a, 605b (referred to collectively as joysticks 605). Joysticks 605 can be the same as or similar to joysticks 505, in some instances. In some embodiments, as discussed herein, the joysticks 605 can serve as the multi-action activation of an autonomous mode of the machine 100 (in some instances, in addition to their ability to control the left and right tracks of the machine, etc.). For example, an autonomous mode of the machine 100 may be activated through pushing each joystick 605 outward (i.e., to an outside of the remote/user interface 680). As soon as one of the joysticks 605 is not pushed fully outward, the autonomous mode may stop and machine 100 may return to manual mode.

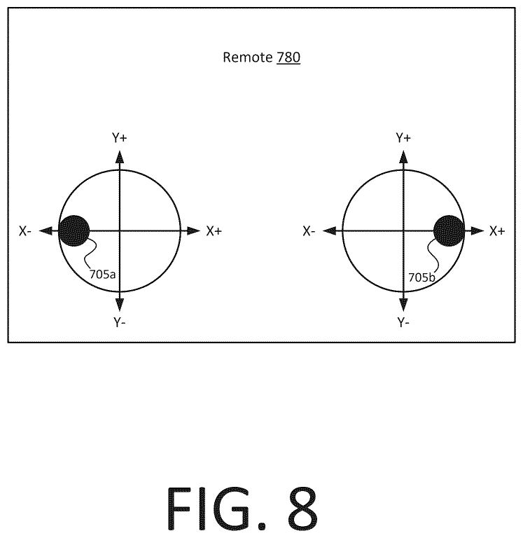

FIGS. 7 and 8 illustrate an example user interface with a disengaged multi-action activation (depicted in FIG. 7) and an engaged multi-action activation (depicted in FIG. 8). In some embodiments, the user interface illustrated in FIGS. 7 and 8 is a remote 780. Remote 780 may be the same as/similar to user interface 180, user interface 580, and/or user interface 680, in some instances. As discussed herein, machine 100 can be configured to be hybrid autonomous, where the machine 100 can be in an autonomous mode or a manual mode and can be switched back and forth between them. In order to switch from manual mode into autonomous mode, a multi-action activation may be used. As discussed herein, the multi-action activation can be a safety feature to help engage the operator while the machine is in autonomous mode, which can better allow for the operator to switch back to manual mode if beneficial for the machine 100 and its surroundings (for example, if the machine 100 was navigating certain terrains, slopes, obstacles, etc.). The multi-action activation can also be beneficial in instances where an operator may no longer be able to perform operating duties (for example, due to health issues such as stumbling and/or passing out and/or any other even momentary incapacitation), as any incapacitation of the operator would result in at least one of the actions being released (e.g., releasing a joystick) thus stopping an autonomous mode.

In some embodiments, as discussed herein, the autonomous multi-action activation can be a two-action activation. In an example, the controls on the user interface/remote 780 that engage the two actions are joysticks 705a, 705b (referred to collectively as joysticks 705). A joystick can be a control (for example, a lever) that can be moved in multiple directions/angles. These different directions/angles can be different controls, in some instances. For remote 780, the joysticks 705 can move in at least four directions—a positive and negative (+and −) X-direction and a positive and negative (+and −) Y-direction (depicted in FIGS. 7 and 8).

In some embodiments, when the autonomous mode is deactivated/disengaged (i.e., when the machine 100 is in a manual mode), the joysticks 705 may be in a central or neutral position (for example, as the joysticks 705 may default to when not being moved by an operator). This neutral position of the joysticks 705 is depicted in FIG. 7. In some embodiments, the autonomous mode may be deactivated/disengaged (i.e., the machine 100 may be in a manual mode) when the joysticks 705 are in any position other than fully outwards is the X-direction, as depicted in FIG. 8. Therefore, moving joystick 705a in a Y+ direction, an X+ direction (as this direction is inward on the joystick 705a side of the remote 780), and/or a Y− direction may not trigger/activate autonomous mode, even if joystick 705b is in an outward position (depicted in FIG. 8). Similarly, moving joystick 705b in a Y+ direction, an X− direction (as this direction is inward on the joystick 705b side of the remote 780), and/or a Y− direction may not trigger/activate autonomous mode, even if joystick 705a is in an outward position (depicted in FIG. 8). Direction 710a shows the direction/movement to move joystick 705a into its autonomous position/action and direction 710b shows the direction/movement to move joystick 705b into its autonomous position/action.

FIG. 8 depicts the joysticks 705 in their outwards (i.e., outmost) positions/actions, thus engaging an autonomous mode of the machine 100. As discussed herein, the outwards position for the 705a joystick (i.e., the left joystick) is in the X− direction (also referred to as the negative X direction), and the outwards position for the 705b joystick (i.e., the right joystick) is in the X+ direction (also referred to as the positive X direction). Outwards, as referred to herein, can refer to the horizontal direction (e.g., X direction) that goes towards an outer edge of the remote 780.

In some embodiments, as discussed herein, once joysticks 705 are both in their outward position (as depicted in FIG. 8) the machine 100 may go into an autonomous mode. However, as soon as one of the joysticks is out of its outward position (for example, starting to go towards the center of the joystick 705, going a different direction, released by the operator all together, etc.), the machine 100 may return to a manual mode. In some embodiments, the joysticks 705 can be moved into their outward positions simultaneously (or at least at a substantially similar time) in order to be considered a two-action activation and activate the autonomous mode.

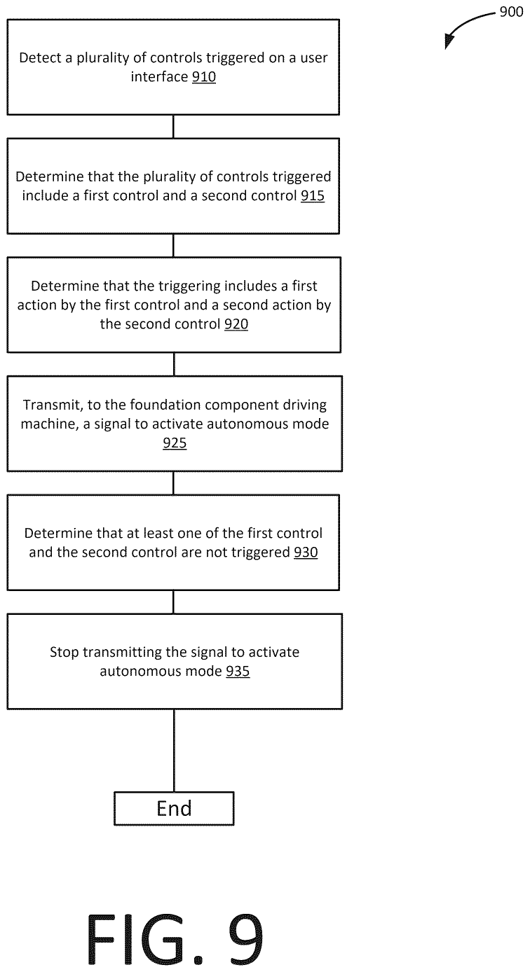

FIG. 9 illustrates an example method 900 for activating (and, in some instances, deactivating) an autonomous mode of a foundation component driving machine, in some embodiments. In some embodiments, method 900 is executed by a program operatively connected to a user interface (e.g., user interface 180, user interface 580, user interface 680, and/or remote 780). In some embodiments, the program is a software program within and/or connected to the user interface. In some embodiments, as discussed herein, the user interface can be connected to (e.g., communicatively coupled to) a controller of a foundation component driving machine (e.g., machine 100).

Method 900 can include operation 910 to detect a plurality of controls triggered on a user interface. As discussed herein, a user interface can include an autonomous activation/deactivation control to allow an operator to switch back and forth between manual control and autonomous control of the machine. In some embodiments, the autonomous activation/deactivation control on the user interface may be a multi-action control/activation (for example, a two trigger/action control). The multi-action activation can occur when multiple actions/triggers have been performed by controls on the user interface. When multiple actions have been performed, a plurality of controls can be detected to have been triggered on the user interface. For example, the user interface can include various controls (e.g., joysticks 505/605, slides 506/606, switches 508/608, button(s) 509, etc.). Detecting that controls have been triggered can include detecting that an operator has engaged (e.g., pressed, moved, slid, twisted, shifted, etc.) the controls. In some embodiments, in order for multiple actions to have occurred, multiple controls may need to be triggered/engaged.

Method 900 can include operation 915 to determine that the plurality of controls triggered include a first control and a second control and operation 920 to determine that the triggering includes a first action by the first control and a second action by the second control. The first action and the second action can be triggered in any order (e.g., triggering the first action and then the second action, triggering the second action and then the first action, triggering both the first action and the second action simultaneously, etc.). In some instances, only specific controls and specific actions may activate an autonomous mode (e.g., an autonomous positioning mode) of the machine. For example, the autonomous mode may not be activated when any multiple controls are triggered (as this could accidentally activate an autonomous mode when an operator may instead be manually performing various actions of the machine) and instead may only be activated when specific controls are triggered in a specific way. An example multi-action activation is an outward position for two joysticks (e.g., joysticks 505/605/705). Put differently, multi-action activation can be activated when an operator pushes each joystick in an outward position. This outward position is depicted in FIG. 8. In this example, the first control can be a first joystick, the second control can be a second joystick, the first action can be the outward position/action of the first joystick, and the second action can be the outward position/action of the second joystick. In some embodiments, the joysticks may need to remain in their outward position (e.g., an operator may need to hold the joysticks in their outward position) in order for the autonomous mode to remain active. This can be a safety feature to help protect the machine and its surroundings.

Method 900 can include operation 925 to transmit, to the foundation component driving machine, a signal to activate autonomous mode of the foundation component driving machine (e.g., machine 100). This can be in response to determining that the plurality of controls triggered include a first control and a second control and determining that the triggering includes a first action and a second action, in some instances. This way, the autonomous mode of the machine may only be activated when the specific controls and actions are engaged/triggered. In some embodiments, as discussed herein, the multi-action activation may be triggered through controls on a user interface. Therefore, in order for the machine itself to enter an autonomous mode, the user interface can transmit a signal to the machine to activate the autonomous mode.

In some embodiments, method 900 can include operation 930 to determine that at least one of the first control and the second control are not triggered. As discussed herein, the first and second actions of the first and second controls (respectively) may need to be occurring, engaged, triggered, etc. in order for the machine to remain in autonomous mode. As soon as any of the actions from the multi-action activation are disengaged/not triggered, the machine may revert back to a manual mode, where an operator can manually control the positioning of the machine (for example, through the user interface). In an example, the first control or the second control may no longer be triggered when an operator lets go of the control (for example, a joystick).

In some embodiments, the first control and the second control may only be triggered when they are undergoing the first action and the second action (respectively). For example, if a control is a joystick, the joystick may have many directions it can be moved in order to control various things on the machine. Each direction may be considered an action of the joystick. In this example, the joystick may need to be moved outward in order to be considered an action that is part of the multi-action activation. Any other actions that the joystick undergoes (e.g., moving inward, upward, downward, etc.) may not trigger an autonomous mode. Therefore, in some instances, the first control or the second control may no longer be triggered if either (or both) the first control or the second control are executing an action different from the first action or the second action (respectively). Therefore, if a joystick is moved from an outward position to a different position (e.g., inward, upward, downward, etc.), the joystick may no longer be considered triggered (with respect to the multi-action activation) even though the joystick is still engaged by an operator.

In some embodiments, method 900 can include operation 935 to stop transmitting the signal to activate the autonomous mode (thus deactivating autonomous mode) of the foundation component driving machine. Stopping the transmitting of the signal to activate the autonomous mode can result in the machine entering a manual mode. For instance, once either of the controls are no longer considered triggered, the machine may stop transmitting the autonomous mode signal (i.e., the signal to activate the autonomous mode). The lack of the autonomous signal can activate the manual mode (i.e., a failure in transmission would result in entering a manual mode (for example, by default).

Advantages of embodiments disclosed herein include improving efficiency and accuracy of positioning a foundation component driving machine for foundation component installation, while maintaining and/or improving safety of the machine and its surroundings containing particulate and preventing it from interfering with sensor performance. For example, a machine can be engaged in an autonomous positioning mode in order to more efficiently and accurately position the machine for foundation component installation. In this example, the machine can be switched to a manual mode in difficult conditions (for example, in certain terrains, slopes, obstacles, etc.) to help protect the machine, its components, and its surroundings.

Thus, embodiments of a hybrid autonomous foundation component driving machine are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A user interface communicatively coupled to a foundation component driving machine, wherein the user interface comprises:
a plurality of controls for controlling components of the foundation component driving machine; and
a multi-action activation for an autonomous mode for the foundation component driving machine, wherein:
the multi-action activation activates the autonomous mode,
the autonomous mode is activated when all of the multi-actions are triggered, and
each action of the multi-action activation is triggered by a control from the plurality of controls.

2. The user interface of claim 1, wherein the autonomous mode for the foundation component driving machine is an autonomous positioning mode for positioning the foundation component driving machine at one or more installation points.

3. The user interface of claim 2, wherein the one or more installation points are determined by a GNSS positioning system.

4. The user interface of claim 1, wherein the multi-action activation is a two-action activation.

5. The user interface of claim 4, wherein the plurality of controls comprise a first joystick and a second joystick, and wherein the two-action activation comprises a first action by the first joystick and a second action by the second joystick.

6. The user interface of claim 5, wherein:
the first action is the first joystick moved to a first outward position; and
the second action is the second joystick moved to a second outward position.

7. The user interface of claim 1, wherein the autonomous mode is activated when all of the multi-actions are triggered simultaneously.

8. The user interface of claim 1, wherein a manual mode of the foundation component driving machine is activated when any of the multi-actions are disengaged.

9. The user interface of claim 1, wherein the user interface is a remote control.

10. The user interface of claim 1, wherein the plurality of controls control at least one of machine tracks, a mast, a rotary driver, a tool driver, a lower crowd motor, and an upper crowd motor of the foundation component driving machine.

11. A machine for positioning and driving foundation components, the machine comprising:
a base machine;
an adjustable mast attached to the base machine;
a rotary driver movably attached to the mast; and
a controller, wherein:
the controller is communicatively coupled to a user interface,
the user interface comprises a multi-action activation for an autonomous mode for the machine, and
triggering the multi-action activation on the user interface causes the controller to execute autonomous control of the machine.

12. The machine of claim 11, wherein the autonomous control is autonomous control for positioning of the machine at one or more installation points.

13. The machine of claim 12, wherein the controller is communicatively coupled to a GNSS base station, and wherein the GNSS base station corrects for atmospheric conditions.

14. The machine of claim 11, wherein the multi-action activation is a two-action activation, and comprises a first action by a first control on the user interface and a second action by a second control on the user interface.

15. The machine of claim 14, wherein:
the user interface comprises a first joystick and a second joystick;
the first action is the first joystick moved to a first outward position; and
the second action is the second joystick moved to a second outward position.

16. A method for activating an autonomous mode of a foundation component driving machine, the method comprising:
detecting a plurality of controls triggered on a user interface, the user interface communicatively coupled to the foundation component driving machine;
determining that the plurality of controls triggered comprise a first control and a second control;
determining that the triggering comprises a first action by the first control and a second action by the second control; and
transmitting, to the foundation component driving machine, a signal to activate the autonomous mode for the foundation component driving machine.

17. The method of claim 16, wherein the autonomous mode for the foundation component driving machine is an autonomous positioning mode for positioning the foundation component driving machine at one or more installation points.

18. The method of claim 16, wherein the first action and the second action are triggered simultaneously.

19. The method of claim 16, wherein:
the first control is a first joystick and the second control is a second joystick;
the first action is the first joystick moved to a first outward position; and
the second action is the second joystick moved to a second outward position.

20. The method of claim 16, further comprising:
determining that at least one of the first control and the second control are not triggered; and
stopping the transmitting of the signal to activate the autonomous mode, resulting in the foundation component driving machine entering a manual mode.
